(19) United States
(12) Patent Application Publication
(10) Pub. No.: US 2002/0007597 A1
(43) Pub. Date: Jan. 24, 2002

(54) Safety gate

(76) Inventor: Tsung-Hsiang Wang, Taipei (TW)

Correspondence Address: Beehler & Pavitt, 100 Corporate Pointe, Suite 330, Culver City, CA, 90230, US

(21) Appl. No.: 09/876,728

(22) Filed: Jun. 6, 2001

(30) Foreign Application Priority Data
Jul. 19, 2000 (TW) 089212475

(51) Int. Cl. E06B 3/32

(52) U.S. Cl. 49/463

(57) ABSTRACT

A safety gate has a horizontal base with first and second vertical bars secured at opposite sides thereof, a door panel provided between the first and second vertical bars, and a locking device provided at a first side of the door panel. The door panel has a second side thereof mounted on the second vertical bar. A pivot spindle is formed on the door panel and pivotally fitted in a pivot socket in a horizontal base. A pivoting support is secured on an upper end of the second vertical bar corresponding to a pivoting bearing secured on an upper end of the second side of the door panel. The door panel returns from an open position to a closed position due to gravity, and the return of the door panel is smooth and slow because of a helical mating in the pivoting support.

### BACKGROUND OF THE INVENTION

1. Field of the Invention

The present invention relates to a safety gate with an improved pivotal supporting structure, which provides security and convenient use for users.

2. Description of Related Art

A safety gate is adapted to a doorframe or a passageway to restrict the movement of small children from a dangerous area such as a stairway.

As shown in FIG. 9, a conventional safety gate normally has a horizontal base (40), first and second vertical bars (41, 42) respectively secured at two opposite ends of the horizontal base (40), a door panel (43) provided between the first and second vertical bars (41, 42) and pivotally mounted on the second bar (42), and a locking device (44) provided on an upper end of the door panel (43). Whereby the door panel (43) is pivotal about the second vertical bars (42) between a closed position in which the door panel (43) is locked with the first vertical bar (41) and an open position in which the door panel (43) is unlocked with the first vertical bar (41).

Because upper and lower pivotal bearings (45, 46) of the door panel (44) are respectively formed with two inclined surfaces to mate with two corresponding inclined surfaces of the second vertical bar (42), and the door panel (40) is mounted in an offset position with respect to the first and second vertical bars (41, 42), after the door panel (44) is opened, it automatically returns to the closed position due to gravity.

A main drawback of the aforesaid conventional safety gate is that the automatic closing operation of the door panel (43) relies on many independent factors, such as the upper and lower pivotal bearings (45, 46), the mating of the inclined surfaces of the upper and lower pivotal bearings (45, 46) and the corresponding inclined surfaces of the second vertical bar (42), the offset angle of the door panel (43), so that to make a precise cooperation of all these factors results in excessive high costs. If the offset angle of the door panel (43) is not large enough, the door panel (43) is not able to turn back to the closed position automatically. If the offset angle of the door panel (43) is too large, the door panel (43) turns back to the closed position at an excessive speed whereby a child might be seriously injured by the door panel (43).

A further shortcoming of the conventional safety gate is that the inclined surfaces are all flat surfaces, however, the movement of the door panel (43) is along a helical path, therefore the door panel (43) does not pivot smoothly.

Therefore, it is an objective of the invention to provide an improved safety gate to mitigate and/or obviate the aforementioned problems.

### SUMMARY OF THE INVENTION

A main object of the present invention is to provide a safety gate having an efficient and economical pivotal supporting structure to ensure a door panel thereof is able to automatically return to a closed position in a smooth and slow way so as to provide user security and convenient use.

A further object of the present invention is to provide a safety gate having a retaining means and a locking device, which permit only adults to open the safety gate, and prevent children from undesirably opening the safety gate. Other objects, advantages and novel features of the invention will become more apparent from the following detailed description when taken in conjunction with the accompanying drawings.

### BRIEF DESCRIPTION OF THE DRAWINGS

FIG. 1 is a plan view of a safety gate in accordance with the invention;

FIG. 2 is an exploded perspective view of a pivotal supporting portion of the safety gate in accordance with the invention;

FIG. 3 is an exploded perspective view of a pivotal bearing of the safety gate in accordance with the invention;

FIG. 4 is a front plan view of the assembly of the pivotal supporting portion of the safety gate of the present invention;

FIG. 5 is a rear plan view of the assembly of the pivotal supporting portion of the safety gate in FIG. 4;

FIG. 6 is a cross sectional view of the assembly of the pivotal supporting portion of the safety gate in accordance with the present invention along a line 6-6 in FIG. 4;

FIG. 7 is a schematic plan view of the safety gate of the present invention, showing the door panel being lifted;

FIG. 8 is a plan view of another embodiment of the safety gate in accordance with the invention; and

FIG. 9 is a plan view of a conventional safety gate.

### DETAILED DESCRIPTION OF THE PREFERRED EMBODIMENT

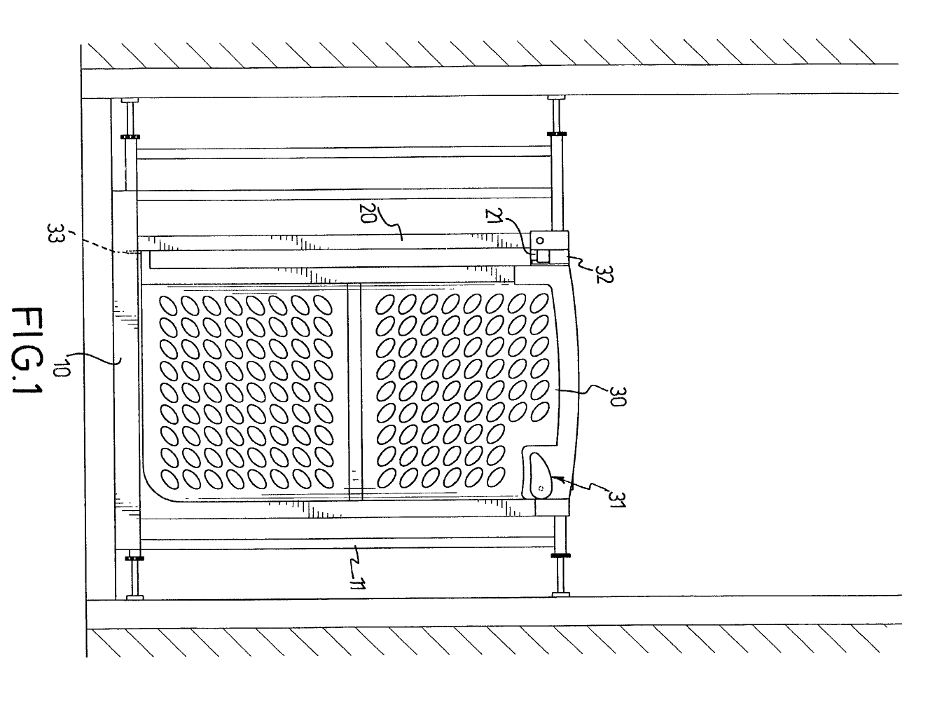

As shown in FIG. 1, a safety gate according to the present invention comprises a horizontal base (10), first and second vertical bars (11, 20), a door panel (30) and a locking device (31).

The first and second vertical bars (11, 20) are respectively secured at opposite sides of the horizontal base (10). The door panel (30) is provided between the first and second vertical bars (11, 20). The locking device (31) is provided on an upper end of a first side of the door panel (30) to permit the door panel (30) to be engaged or disengaged with the first vertical bar (11).

A second side of the door panel (30) is pivotally mounted on the second vertical bar (20). The upper end of the second side of the door panel (30) is provided with a pivoting bearing (32) corresponding to a pivoting support (21), which is provided at an upper end of the second vertical bar (20). The lower end of the door panel (30) is formed with a pivot spindle (33) extending vertically downward. A pivot socket is defined in the base (10) to receive the pivot spindle (33) pivotally fitted therein.

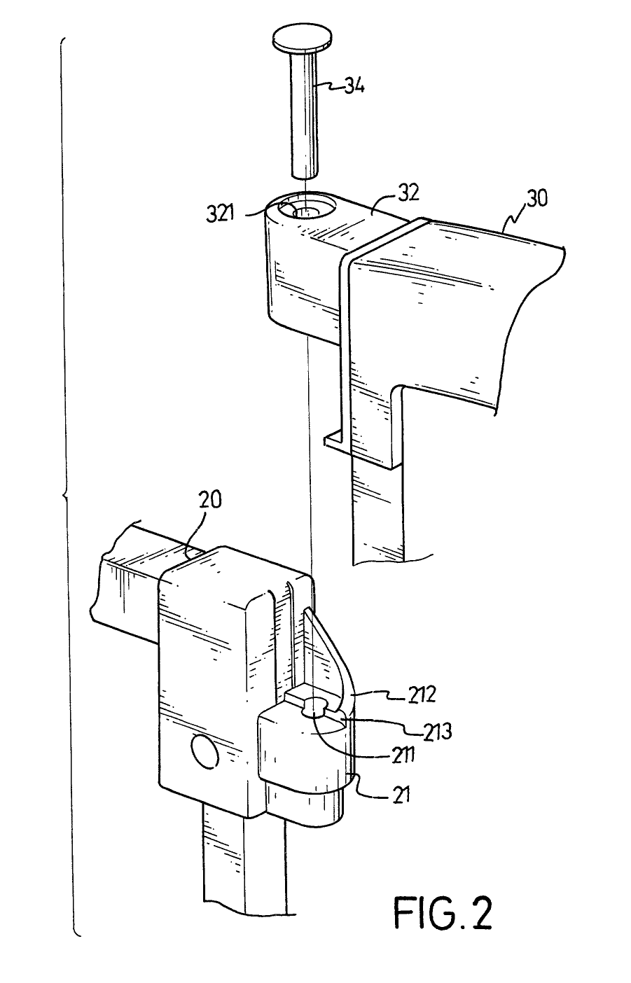

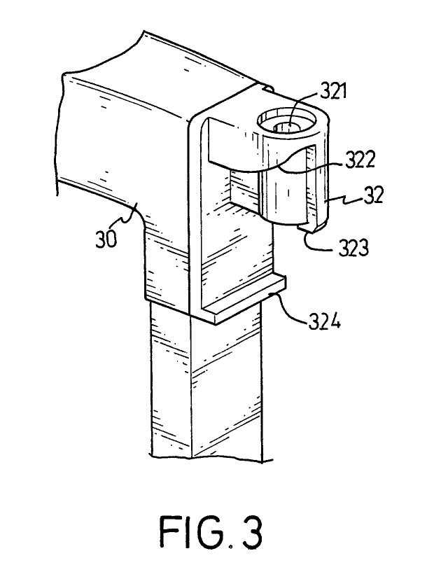

With reference to FIGS. 2 and 3, the pivoting support (21) has a vertically extending pivot hole (211) defined in a center thereof, and a lower mating part (212) formed at one side of an upper end thereof. The lower mating part (212) has a lower spiral mating face formed on an upper surface thereof. A retaining step (213) is formed on the upper end of the pivotal support (21) and halfway across the pivot hole (211), whereby a front face of the step (213) is substantially parallel to a direction of the door panel (30) when locked in its closed position. The pivoting bearing (32) has a vertically extending pivotal hole (321) defined in a center thereof corresponding to the pivot hole (211), and an upper mating part (322) formed at one side of a lower end thereof corresponding to the lower mating part (212). The upper mating part (322) has an upper spiral mating face formed on a lower surface thereof corresponding to the lower spiral mating face of the lower mating part (212). A stop step (323) is formed on the lower end of the pivoting bearing (32) corresponding to the retaining step (213). A pivot bolt (34) substantially co-axial to the pivot spindle (33) is extended through the pivotal hole (321) of the pivoting bearing (32) and the corresponding pivot hole (211) of the pivoting support (21). Whereby the door panel (30) is pivotal about the pivot bolt (34) and the pivot spindle (33) between an open position and a closed position.

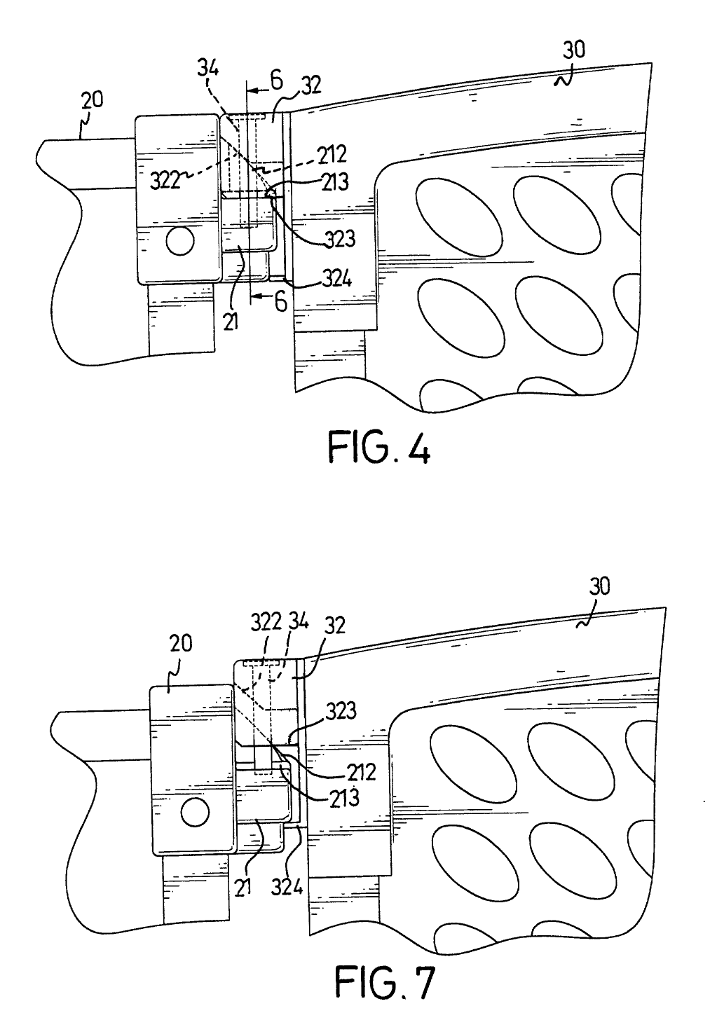

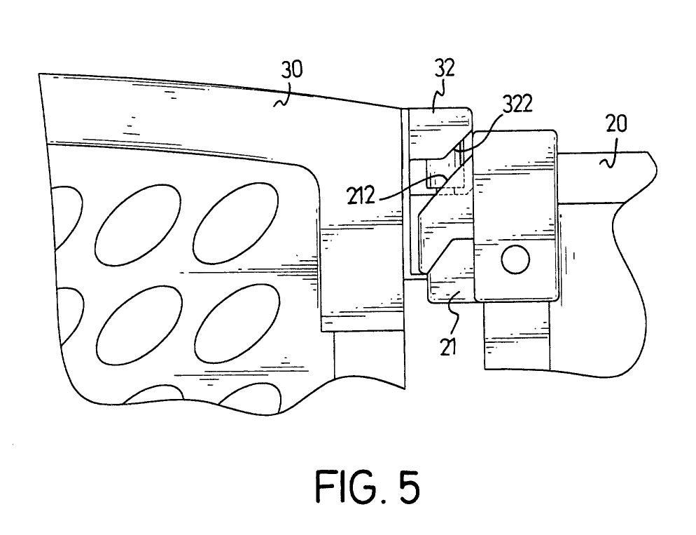

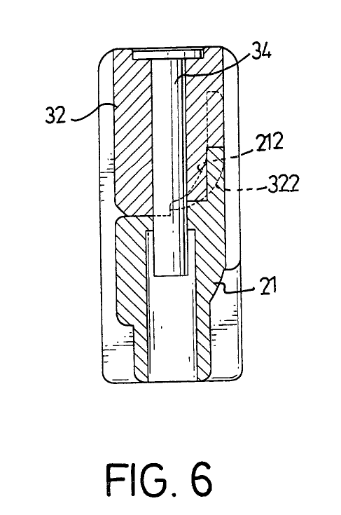

Now with reference to FIGS. 4 to 6, when the door panel (30) is turned to the closed position, a protrusion portion of the stop step (323) is retained by a side face of the retaining step (213), and the upper spiral mating face of the upper mating part (322) is abutted against the lower spiral mating surface of the lower mating part (212). Therefore after the door panel (30) is locked with the first vertical bar (11) by the locking device (31), the door panel (30) is securely retained at the closed position. If the locking device (31) of the door panel (30) is released, as the protrusion portion of the upper step (323) is retained by the side face of the lower step (213), the door panel (30) is still retained at the closed position.

To open the safety gate, first the door panel (30) must be lifted by an adult so that the stop step (323) is freed from restriction of the retaining step (213), then the door panel (30) is pressed or pulled by the adult to an open position.

Afterwards, the door panel (30) returns automatically by gravity to its closed position, during which the upper spiral mating surface of the upper mating part (322) slides smoothly and slowly along the lower spiral mating face of the lower mating part (212), and then locks with the first vertical bar (11) by the locking device (31) at the closed position.

It can be appreciated that the present invention with aforesaid structure has following advantages:

1. the door panel (30) is securely retained at the closed position, even though the locking device is released, so that it is difficult for small children but very easy for the adult to open the door panel (30) if it is lifted first and then pressed or pulled by the adult;

2. the door panel (30) can automatically turn from the open position to the closed position automatically in a smooth and slow way due to the upper and lower spiral mating faces of the upper and lower mating parts (322, 212), which prevents children who are close the door panel (30) from being otherwise hurt;

3. the pivotal supporting structure is simple, efficient and reliable, so that the production cost of the safety gate is economical.

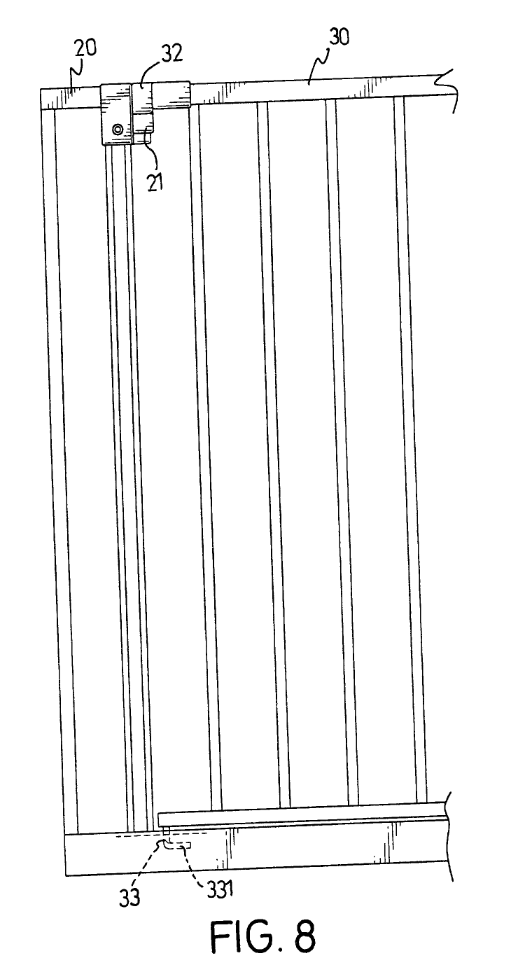

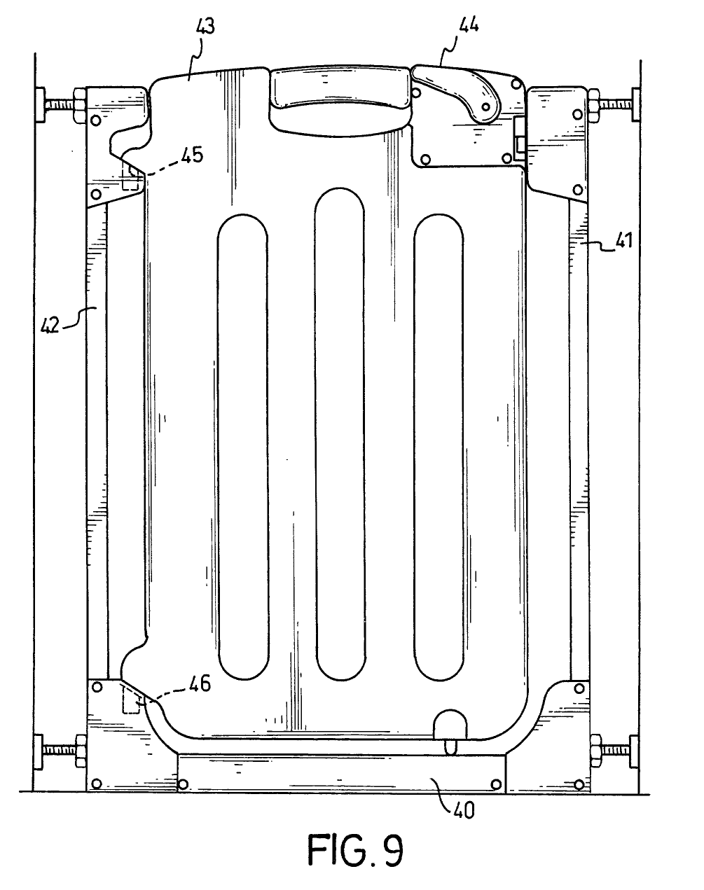

As seen in FIGS. 3, 4 and 7, a retaining flange (324) is formed at a lower end of the pivoting bearing (32). The retaining flange (324) limits a length scope for lifting of the door panel (30) in order to prevent the door panel (30) from being completely detached from the second vertical bar (20). According to the present invention, another practicable embodiment is shown in FIG. 8. A horizontally extending limiting part (331) is formed at a lower end of the pivot spindle (33). The pivot spindle (33) with the limiting part (331) is pivotally fitted in a pivot socket in the base (10). The limiting part (331) permits the door panel (30) to be lifted within the length scope that prevents the door panel (30) from being completely detached from the second vertical bar (20).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A safety gate comprising a horizontal base, first and second vertical bars respectively secured at opposite ends of the horizontal base, a door panel provided between the first and second vertical bars, and a locking device provided at an upper end of a first side of the door panel to lock the door panel with the first vertical bar; wherein the improvements comprise:
a second side of the door panel being pivotally mounted on the second vertical bar by a pivotal supporting structure, which includes:
a vertically extending pivot spindle integrally formed at a lower end of the second side of the door panel, and a pivot socket defined in the base to receive the pivot spindle pivotally fitted therein;
a pivoting support securely provided at an upper end of the second vertical bar, and having a lower pivot hole defined therein and extending vertically, a lower mating part formed at one side of an upper end thereof, and a lower spiral mating face formed on an upper surface of the lower mating part;
a pivoting bearing securely provided at an upper end of the second side of the door panel, and having an upper pivot hole defined therein and extending vertically corresponding to the lower pivot hole, an upper mating part formed at one side of a lower end thereof corresponding to the lower mating part, and an upper spiral mating face formed on a lower surface of the upper mating part corresponding to the lower spiral mating face; and
a pivot pin extended through the upper pivot hole of the pivoting bearing and the lower pivot hole of the pivoting support,
whereby the door panel is pivotally mounted on the second vertical bar and pivotal between an open position and a closed position, after the door panel is opened, the door panel returns automatically by gravity to the closed position, and the upper spiral mating face of the upper mating part slides along the lower spiral mating face of the lower spiral mating part in slow and smooth way.

2. The safety gate as claimed in claim 1, wherein a retaining step is formed on an upper end of the pivoting support and extends substantially parallel to the door panel locked in the closed position, a stop step is formed on a lower end of the pivoting bearing and corresponds to the retaining step, whereby when the door panel is turned to the closed position, a protrusion portion of the stop step is retained by a side face of the retaining step to prevent the door panel from being forced in any horizontal direction to turn to an open position.

3. The safety gate as claimed in claim 1, wherein a retaining flange is formed at a lower end of the pivoting bearing to prevent the door panel from being completely detached from the second vertical bar.

4. The safety gate as claimed in claim 1, wherein a horizontally extending limiting part is formed at a lower end of the pivot spindle and pivotally fitted in the pivot socket in the base, so as to prevent the door panel from being completely detached from the second vertical bar.
